(19) United States
(12) Patent Application Publication
(10) Pub. No.: US 2015/0356520 A1
(43) Pub. Date: Dec. 10, 2015

(54) SYSTEM AND METHOD FOR PROVIDING AN INTERACTIVE ASSET MANAGEMENT INTERFACE

(71) Applicant: General Electric Company, Schenectady, NY (US)

(72) Inventors: AARON RICHARD MITTI, ATLANTA, GA (US); RICHARD WILL BAKER, JACKSONVILLE, FL (US); ROBERT WOJCIECHOWSKI, ATLANTA, GA (US); JUSTIN THOMAS GILLAM, OXFORD, MI (US)

(21) Appl. No.: 14/300,588

(22) Filed: Jun. 10, 2014

(51) Int. Cl. G06Q 10/00; G06Q 10/08

(52) U.S. Cl. CPC G06Q 10/20; G06Q 10/087

(57) ABSTRACT

A system and method that provide an interactive asset management interface display a visual representation of equipment under examination and one or more current parts of the equipment. The system and method receive a selection input from an operator of the computing system that identifies a selected part of the current parts of the equipment under examination and obtain state information of the selected part from one or more memory devices responsive to receiving the selection input. The system and method also (a) add the state information to one or more fields of a form used to at least one of acquire one or more replacement parts for the selected part, request repair of the selected part, and/or request inspection of the selected part; and/or (b) display the state information of the selected part using the display device of the computing system with the visual representation of the selected part.

### FIELD

Embodiments of the subject matter described herein relate to assisting in managing assets, such as equipment and parts of the equipment being repaired, replaced, inspected, or the like.

### BACKGROUND

Some known systems are used to assist operators in ordering parts for equipment being repaired. For example, these systems may allow an operator to input identifying information for a part that needs to be repaired or replaced. This information is input into a computing system to allow the operator to order one or more replacement parts.

These systems may require the operator to provide the information needed to obtain the replacement part using keyed entries through a series of drill down menus or lists, such as a tree list. This manner of inputting the information can be a difficult process because these lists can be lengthy, and identifications of the parts are often abbreviated in different ways, which can make it difficult for the operator to find the part being replaced or ordered in a list. Additionally, the operator may not know where the exact replacement part or part being replaced is to be found in a list.

Once a replacement part is ordered, the operator may have to then call or travel to a variety of different locations in order to acquire the replacement part. The inventory of replacement parts at these different locations may not be centralized. As a result, considerable time may be spent trying to find out where the replacement part may be available.

### BRIEF DESCRIPTION

In one embodiment, a method (e.g., for providing an interactive asset management interface to an operator) includes displaying (e.g., using a display device of a computing system having one or more processors) a visual representation of equipment under examination and one or more current parts of the equipment under examination. The method also can include receiving (e.g., using the computing system) a selection input from an operator of the computing system that identifies a selected part of the one or more current parts of the equipment under examination and obtaining state information of the selected part from one or more memory devices responsive to receiving the selection input. The method also can include at least one of: adding the state information to one or more fields of a form used to at least one of acquire one or more replacement parts for the selected part, request repair of the selected part, or request inspection of the selected part; and/or displaying the state information of the selected part using the display device of the computing system with the visual representation of the selected part.

In another embodiment, a system (e.g., an asset management system) includes a computing system having one or more processors. The one or more processors are configured to direct a display device to present a visual representation of equipment under examination and one or more current parts of the equipment under examination. The one or more processors also are configured to receive a selection input from an operator of the computing system that identifies a selected part of the one or more current of the equipment under examination and to obtain state information of the selected part from one or more memory devices responsive to receiving the selection input. The one or more processors also are configured to at least one of: add the state information to one or more fields of a form used to at least one of acquire one or more replacement parts for the selected part, request repair of the selected part, and/or request inspection of the selected part; and/or display the state information of the selected part using the display device of the computing system with the visual representation of the selected part.

In another embodiment, a system (e.g., an asset management system) includes a computing system having one or more processors configured to direct a display device to present a visual representation of equipment under examination and one or more current parts of the equipment under examination. The one or more processors also are configured to direct the display device to display an object model representation of the equipment under examination. The computing system is configured to receive input from the operator to move one or more of the component object models and/or one or more of the replacement object models to indicate at least one of removal of the one or more current parts and/or addition of one or more of the replacement parts.

### BRIEF DESCRIPTION OF THE DRAWINGS

The subject matter described herein will be better understood from reading the following description of non-limiting embodiments, with reference to the attached drawings, wherein below:

FIG. 1 illustrates a schematic diagram of an asset management system according to one embodiment;

FIGS. 2A and 2B illustrate a flowchart of a method for providing an interactive user interface for asset management according to one embodiment;

FIG. 3 illustrates a perspective view of a computing system shown in FIG. 1 having a display device also shown in FIG. 1 that is presenting a visual representation of equipment under examination according to one embodiment;

FIG. 4 illustrates another visual representation of the equipment shown in FIG. 3 that can be shown on the display device shown in FIG. 1 according to one embodiment;

FIG. 5 illustrates an electronic form that may be at least partially completed by the computing system shown in FIG. 1 according to one embodiment;

FIG. 6 illustrates another example of a visual representation that may be displayed on the display device shown in FIG. 1 of the computing system shown in FIG. 1 according to one embodiment;

FIG. 7 illustrates another visual representation that may be presented to the operator by the computing system shown in FIG. 1 according to one embodiment;

FIG. 8 illustrates a perspective view of other equipment under examination according to one embodiment; and

FIG. 9 is an example of an object model representation of the equipment shown in FIG. 8 that may be generated by the computing system shown in FIG. 1 for display to the operator in accordance with one embodiment.

### DETAILED DESCRIPTION

One or more aspects of the inventive subject matter described herein relate to systems and methods for providing an interactive asset management user interface. This interface can be used by an operator that is working on equipment under examination (such as, but not limited to, vehicles) to, among other things, inspect, repair, or replace one or more parts of the equipment under examination. The systems and methods provide an interactive interface on a computing system (e.g., a handheld computer, a mobile phone, a desktop computer, a laptop computer, or the like) that illustrates a two-dimensional (2D) or three-dimensional (3D) visual representation (e.g., a model or image) of equipment being repaired, inspected, or the like, by an operator. The operator can use this interface to zoom in (e.g., change a magnification of the image), rotate, explode the view to show individual parts of the equipment, or the like, using multi-touch gestures. Individual parts of the equipment can be selected by the operator to reduce key-in of part information in one or more forms. For example, if the operator wants to replace a part (e.g., a wheel, circuit board, pump, conduit, fluid, or the like) of a vehicle, the operator can select the part from the visual representation and state information of the part (e.g., identity of the part, condition of the part, age of the part, etc.) can be automatically filled in a form on the computing system. This form may then be used to order or otherwise acquire a replacement part. Optionally, the interface can be used to show the configuration and condition of the equipment (e.g., a railcar, locomotive equipment, other types of rolling equipment, wayside assets, or other types of equipment) in a graphical model view to provide better contextual information of the equipment and parts. The operator can use the interface to individually select parts to allow other actions to be taken (e.g., replace the part, cause the interface to display additional details of the part, etc.). Additional graphical data may be overlaid onto the image using charts, graphics, colors, or the like, to display configuration information and condition information of the part that is selected by the operator. The configuration information can indicate how the part is placed and/or is being used in the equipment, and the condition information can indicate the age, repair history, damage, remaining service life, location, usage history, or the like, of the selected part.

This interface can be easier for operators to use to obtain information about individual parts, to order replacement parts, and the like, and can reduce the time needed for the operators to enter information in forms needed to acquire parts or work. The interface also can provide additional information to the operator upon selection of one or more parts to make more information available at once to the operator and allow the operator to make smarter and more informed decisions.

In another aspect, the system and method provide an interface that provides operators with the ability to view objects that symbolize the actual equipment in two-dimensional and/or three-dimensional representations and interact with the representations, such as via gestures on a touchscreen or other device. The systems and methods can provide a multi-level, drill-in interface that zooms into various levels of detail shown on the equipment. Different parts of the equipment can be shown as draggable boxes (or other objects) which can be moved in and/or out of different areas with electronic mouse gestures, touch gestures, or other actions. The boxes (or other objects) can be expanded or collapsed to show additional detail and sub-component boxes. The component boxes (or other objects) can be modeled to symbolize the physical relationships of the parts of the equipment.

In another aspect, the interface generated by the systems and methods can allow the operator to select a part for replacement and then determine other locations that have inventories of replacement parts (e.g., spares). The computing system that generates the interface can clearly identify the quantity of spares in the different inventories, such as by listing the quantities in different colors or otherwise. For example, a red color (or other designated color) may indicate that the location has no spares or has to keep the current inventory of spares on-site due to one or more preexisting contracts, rules, or regulations. The location may be required to keep at least a designated threshold number of spares on-site, and the red color can indicate that the location does not have this threshold number of spares. A yellow color (or other designated color) may indicate that the location has one or more spares, but only has a few spares in excess of the threshold number. A green color (or other designated color) can indicate that the location has many more spares than the threshold number. Optionally, other graphics, icons, colors, or manners of displaying inventories may be used than the aforementioned colors.

The systems and methods optionally can determine distances from the current location of the computing system, operator, and/or equipment to the different locations where inventories of a spare for a selected part are located. The interface can present these distances, along with indications of direction to the different locations, so that the operator can determine how close various inventories of spares are located. Optionally, the interface can provide the operator with instructions on how to travel to a selected location of these inventories. Providing operators with this information for spares for a selected part can help the operators find better locations to get spares from (e.g., in terms of distance and/or inventories), thereby reducing calls to the various locations, reducing working time spent traveling to various locations to determine inventories, reducing fuel usage, preventing depletion of inventories at locations with few spares, and the like.

At least one technical effect provided by the inventive subject matter described herein provides for the reduced time and/or effort for an operator to identify a part to be serviced (e.g., inspected, repaired, and/or replaced), to enter data needed to order the servicing of the part and/or a replacement part into one or more forms, to identify locations where replacement parts are located, to track where various parts or replacement parts are located on equipment, and the like. Another technical effect is the provision of data structures, in a computer memory, that when processed by a computer processor result in the display of plural object models that are configured for operator identification and selection of replacement parts for equipment under examination.

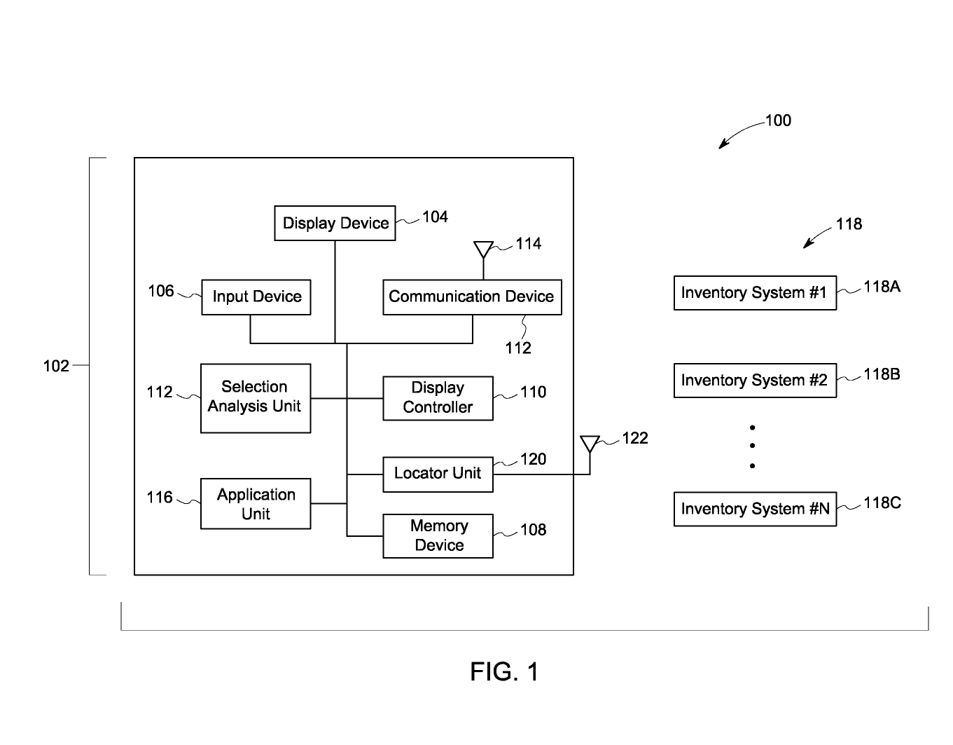

FIG. 1 illustrates a schematic diagram of an asset management system 100 according to one embodiment. The system 100 includes an operator computing system 102 that represents one or more computing systems, such as one or more computers (e.g., desktop computers, laptop computers, tablet computers, or the like), mobile phones, or other electronic devices that include hardware circuits or circuitry that include and/or are connected with one or more processors, such as computer microprocessors. The system 100 includes several components (units, controllers, devices, or the like) that may be embodied in hardware circuits or circuitry that include and/or are connected with one or more processors. As used herein and in the claims, multiple instances of “one or more processors” does not mean that the various systems, unit, components, and the like, are necessarily embodied in different processors, although that is a possibility. Instead, the one or more processors for two or more systems, units, components, or the like, may be one or more of the same processors, such that, in one embodiment, two or more systems, units, components, or the like, are embodied in the same processor or the same multiple processors.

The computing system 102 includes a display device 104 that outputs information to an operator. The display device 104 can include one or more monitors, screens, or the like, that are controllable to visually present information to the operator. Optionally, the display device 104 can include and/or be connected with one or more other output devices, such as speakers, that are controllable to audibly present information to the operator. A display controller 106 of the computing system 102 controls the display device 104 by generating signals that cause the display device 104 to visually present the information to the operator. For example, the display controller 106 can direct the display device 104 to present a visual representation of equipment under examination by the operator. As described herein, this visual representation can include 2D or 3D images of the equipment. The visual representation can be an exploded view of the equipment or a perspective view of the equipment (e.g., that is not exploded). Optionally, the visual representation may be an object model representation, where different parts of the equipment and/or the equipment may be schematically represented by geometric shapes, such as squares, rectangles, circles, or the like. The equipment under examination may be an electrical system, a mechanical system, a pneumatic system, a combination thereof, or another type of system. By way of example only, the equipment may be a vehicle (e.g., a rail vehicle such as a locomotive or rail vehicle, another type of off-highway vehicle such as a vehicle that is not permitted or designed for travel on public roadways, an automobile, an airplane, a marine vessel, or the like), a power generating system, or another type of system.

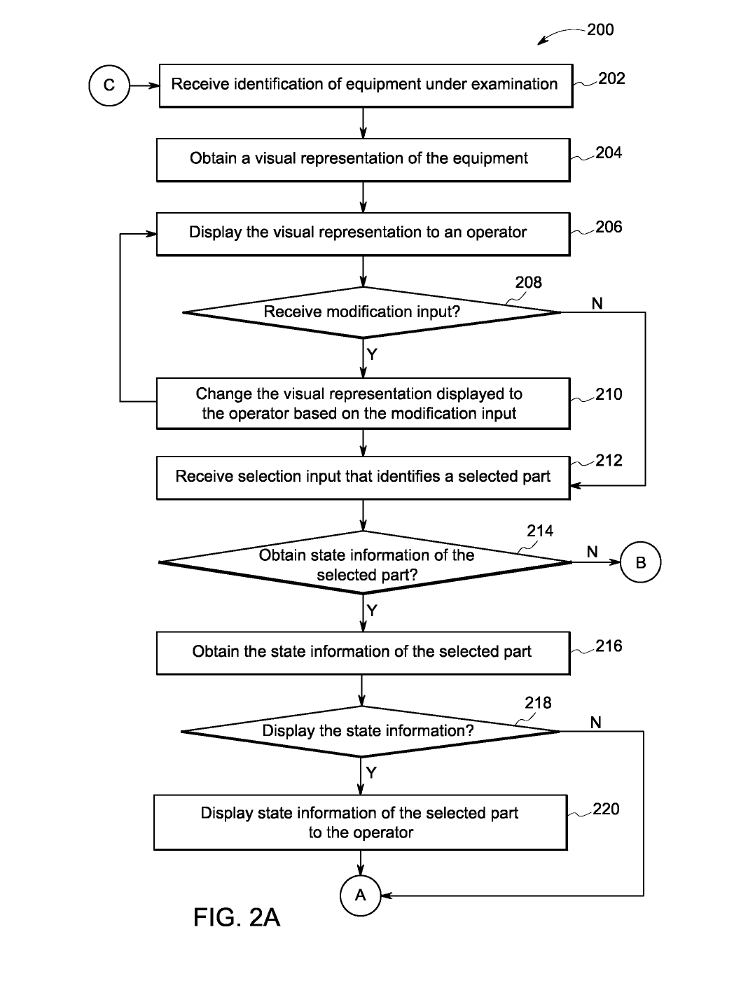

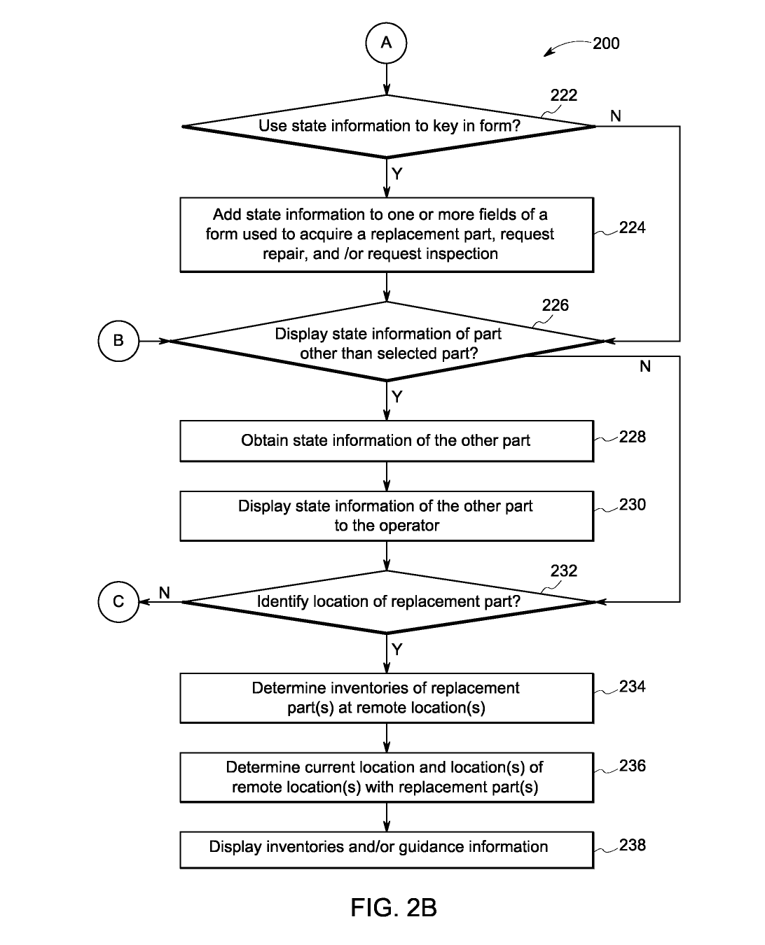

With continued reference to the system 100 shown in FIG. 1, FIGS. 2A and 2B illustrate a flowchart of a method 200 for providing an interactive user interface for asset management according to one embodiment. The method 200 may be performed using one or more components of the system 100 shown in FIG. 1. The assets that are managed using the system 100 and/or method 200 may include various types of equipment and/or parts of the equipment, as described above.

At 202, an identification of the equipment under examination is received. For example, the operator of the system 100 may use an input device 106 (shown in FIG. 1) of the computing system 102 to identify the equipment. The input device 106 can include one or more devices used to convey information to the computing system 102, such as a keyboard, touchscreen, stylus, electronic mouse, microphone, or the like. In one embodiment, the input device 106 and the display device 104 can be included in the same component or components. For example, a touchscreen of the computing system 102 may be both the input device 106 and the display device 104.

In one aspect, the input device 106 can receive the identification of the equipment by optically scanning an image coupled with the equipment. For example, the equipment may have a bar code or other identifying information printed on the equipment, printed on a tag or other body coupled with the equipment, or otherwise associated with the equipment (e.g., printed on a document associated with tasks to be performed on or with the equipment, such as a work order). The input device 106 can include a bar code reader or other imaging device that can obtain an image of the identifying information. This identifying information can be compared with designated identifying information stored on one or more memory devices 108 (shown in FIG. 1) of the computing system 102. The designated identifying information can be stored in the memory device 108 so that different identifying information is associated with different types of equipment. The memory device 108 can represent one or more computer readable storage media, such as a computer hard drive, a solid state memory device, or the like. Optionally, all or part of the memory device 108 may be located outside of the computing system 102 such that the computing system 102 can remotely communicate with the memory device 108.

Optionally, the input device 106 can receive the identification of the equipment by electromagnetically reading identifying data associated with the equipment. For example, the equipment may have a radio frequency identification (RFID) circuit or other circuit and/or antenna that emit electromagnetic signals when interrogated by an electromagnetic field generated by the input device 106 or another device, or when powered by a power source. The input device 106 can include one or more antennas for reading the electromagnetic signals from the equipment (or a tag coupled with the equipment) in order to obtain the identifying information of the equipment.

At 204, a visual representation of the equipment under examination is obtained. This visual representation can be obtained responsive to and/or using the identifying information previously received. For example, upon receiving the identifying information, a display controller 110 (shown in FIG. 1) of the computing system 102 can obtain one or more images (e.g., 2D, 3D, or other images) of the equipment under examination from the memory device 108 or another location. The visual representation that is obtained may not be an exact image of the actual equipment under examination, but may be an image of similar or identical equipment to the equipment under examination (e.g., the same model of equipment).

At 206, the visual representation of the equipment under examination is displayed to the operator. For example, the display controller 110 can generate signals that are sent to the display device 104 to cause the visual representation of the equipment to be displayed on the display device 104.

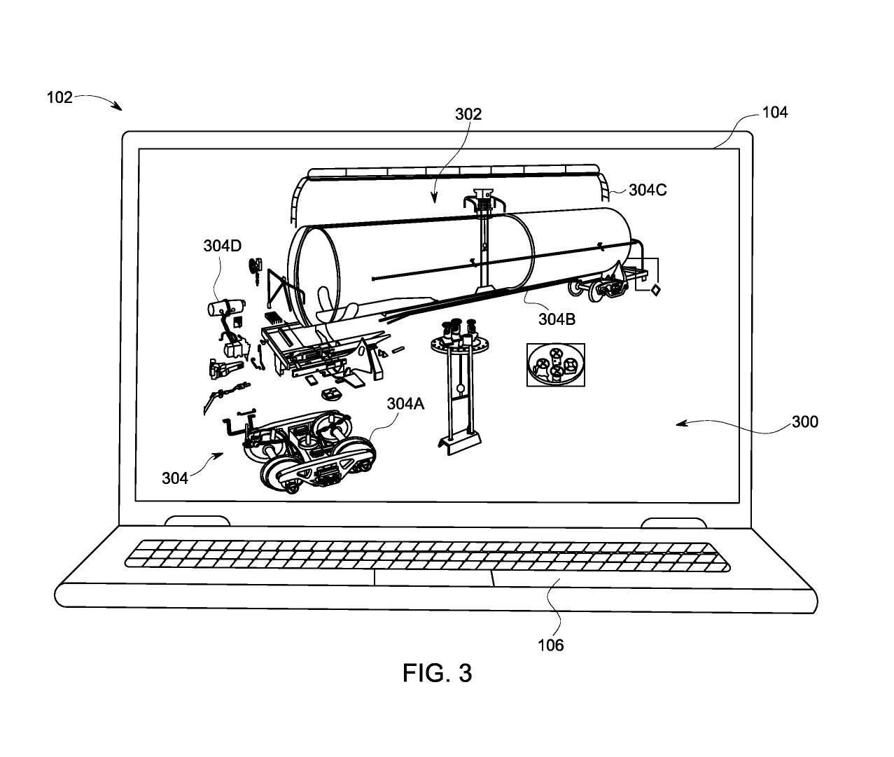

With continued reference to the flowchart of the method 200 shown in FIG. 2, FIG. 3 illustrates a perspective view of the computing system 102 having the display device 104 presenting a visual representation 300 of equipment under examination 302 according to one embodiment. In the illustrated example, the computing system 102 is shown as a laptop computer having a screen as the display device 104 and a keyboard and touch-sensitive area as the input device 106, but optionally may be another type of computing system. The screen of the computing system 102 optionally may be a touchscreen that can detect the touch of the operator. The visual representation 300 displays the equipment 302 as being a tank rail car, but optionally may be another type of rail vehicle, another type of vehicle, or equipment other than a vehicle.

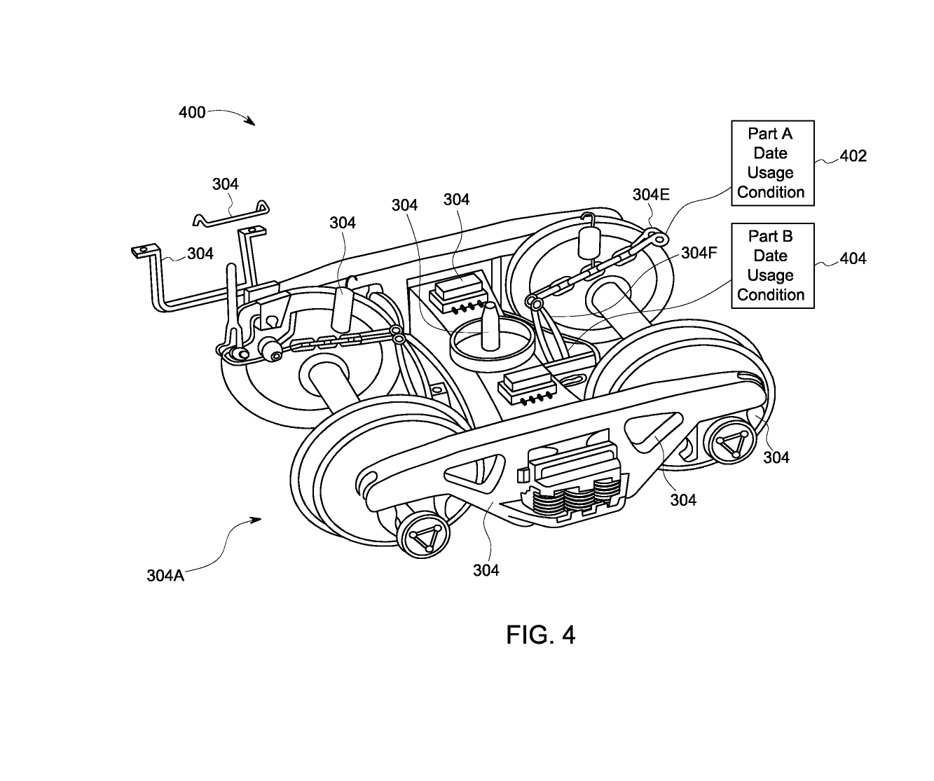

The visual representation 300 is a 3D exploded view of the equipment 302 in FIG. 3. For example, several parts 304 (e.g., parts 304A-F, with parts 304E, 304F shown in FIG. 4) of the equipment 302 may be mechanically coupled with each other during operation of the equipment 302, but are shown in the visual representation 300 as decoupled and spaced apart from each other. Alternatively, the visual representation 300 may initially be shown to the operator in a non-exploded view.

At 208, a determination is made as to whether the computing system 102 has received modification input to change the visual representation 300 shown on the display device 104. For example, the operator may use the input device 106 to rotate the visual representation 300 of the equipment 302 as shown on the display device 104. If the display device 104 and/or input device 106 includes a touch sensitive device (e.g., a touchscreen or touch sensitive electronic mouse or touch sensitive pad/area), then the operator optionally may touch a portion of the display device 104 and/or input device 106 and drag his or her finger in one or more directions to rotate the visual representation 300. As another example, the operator may use the input device 106 to magnify the visual representation 300 of the equipment 302 as shown on the display device 104. If the display device 104 and/or input device 106 includes a touch sensitive device (e.g., a touchscreen or touch sensitive electronic mouse), then the operator optionally may touch a portion of the display device 104 and/or input device 106 with two or more fingers and drag the fingers in different directions to zoom in or out of the visual representation 300. As another example, the operator may use the input device 106 to change the perspective of the equipment 302 shown in the visual representation 300. For example, the operator may change which side of the equipment 302 is shown on the display device 104, may change whether the equipment 302 is shown in an exploded or non-exploded view, may change whether a 2D or 3D image of the equipment 302 is shown, may change whether an object model representation (described herein) of the equipment 302 is shown, or the like. Optionally, other modification inputs may be provided.

If modification input is provided by the operator, then the computing system 102 can change the manner in which the visual representation 300 of the equipment 302 is shown on the display device 104. As a result, flow of the method 200 can proceed to 210. On the other hand, if no modification input is received, or the modification input that is received does not request a change in the manner in which the equipment 302 is shown on the display device 104, then flow of the method 200 can proceed to 212 without changing the visual representation 300.

At 210, the visual representation 300 of the equipment 302 is changed. The visual representation 300 can be changed responsive to and based on the modification input provided by the operator. For example, the display controller 110 of the computing system 102 can examine the modification input and generate signals to the display device 104 to modify how the equipment 302 is shown on the display device 104. If the modification input requests a change in magnification, then the display controller 110 can direct the display device 104 to alter the visual representation 300 to zoom in or zoom out of the equipment 302. Other appropriate modifications may be made by the display controller 110 in connection with the various types of modification input described herein. Flow of the method 200 can return to 206 so that the visual representation 300 of the equipment 302, as altered by the modification input, can be shown to the operator and the operator has the option of changing the visual representation 300 one or more additional times.

At 212, the computing system 102 receives a selection input from the operator. The selection input can be provided using the input device 106, and may identify one or more parts 304 of the equipment 302 as a selected part 304. A selection analysis unit 112 (shown in FIG. 1) of the computing system 102 detects the selection input from the input device 106, such as by determining which area or areas of the displayed visual representation 300 are selected by the operator and determining which parts 304 that the area or areas selected by the selection input correspond to.

The part 304 may be selected if the operator wants to view information about the part 304 (referred to herein as state information about the part), wants to view information about other parts 304 that are coupled with or interconnected with the selected part 304, wants to find one or more replacement parts 304 for the selected part 304, wants to request repair and/or inspection of the selected part 304, or the like. The operator can provide the selection input by using the input device 106 to identify at least one of the parts 304. For example, the operator can touch the area of the display device 104 where the part 304 to be selected is located. Alternatively, the operator can use an electronic mouse, keyboard, stylus, or the like, to select a part 304.

At 214, a determination of whether state information of the selected part is to be obtained is performed. For example, the computing system 102 may determine whether the operator has indicated (e.g., via the input device 106) that he or she wants to view state information about the selected part 304. The state information can represent one or more aspects of the selected part 304, such as an identity of the selected part 304 (also referred to as a job identifier), a condition of the selected part 304, an age of the selected part 304, a duration of use of the selected part 304, a service history of the selected part 304, a location of the selected part 304 in the equipment 302, a quantity of the selected part 304 in the equipment 302, a quantity of replacement parts to be acquired to replace or repair the selected part 304, or the like.

The identity of the selected part 304 can include an alphanumeric code or other information that represents and/or distinguishes the selected part 304 from one or more other parts 304, such as a model number, serial number, or the like. The condition of the selected part 304 can indicate if the selected part 304 is new, is used, has been refurbished, is damaged, or the like. The age of the selected part 304 can indicate when the part 304 was created, when the part 304 was placed into service, or the like. The duration of use of the selected part 304 can represent how long the part 304 has been used, such as the service life of the part 304. The duration of use of the selected part 304 can indicate how long the part 304 has been connected with the equipment 302, how long the part 304 has been in active use on the equipment 302 (e.g., excluding time periods when the equipment 302 was dormant or otherwise not operating), or the like.

The service history of the selected part 304 can indicate the number, frequency, dates, or the like, of previous repairs, inspections, etc., of the part 304. The service history optionally may include when the part 304 is scheduled or due for a subsequent replacement, repair, inspection, or the like. The location of the selected part 304 can represent where the part 304 is located on or in the equipment 302. For example, the location can include a code representative of a general or specific location of the part 304 on the equipment 302 (e.g., front, left, right, top side, etc.). The quantity of the selected part 304 in the equipment 302 can represent the number of similar or identical parts 304 in the equipment 302. For example, for an automobile having four wheels, selection of one wheel as a selected part 304 may be associated with state information that includes a quantity of four total wheels in the equipment 302 and/or three additional wheels in the equipment 302. The quantity of replacement parts may represent the number of replacement parts that may be needed to replace or repair the selected part 304. For example, if the selected part 304 is formed from several other parts (e.g., sub-parts or components), then multiple, different replacement parts may be needed to repair or replace the selected part 304.

If the state information is to be obtained for the selected part 304, then flow of the method 200 can continue to 216. Otherwise, flow of the method 200 may proceed to 226 (shown in FIG. 2B). At 216, the state information of the selected part 304 is obtained. In one aspect, the selection analysis unit 112 of the computing system 102 acquires the state information for the selected part 304 from the memory device 108. Optionally, the selection analysis unit 112 can obtain the state information from another location, such as a memory device other than the memory device 108.

At 218, a determination is made as to whether the state information for the selected part 304 is to be displayed on the computing system 102. For example, the computing system 102 may determine if the operator has requested that the state information be shown, if the default setting or current setting of the computing system 102 is to display the state information, or if the computing system 102 is otherwise instructed to display the state information for the selected part 304. If the state information for the selected part 304 is to be displayed, then flow of the method 200 can proceed to 220. Otherwise, flow of the method 200 can proceed to 222 (shown in FIG. 2B).

At 220, the state information of the selected part 304 is displayed. For example, the display controller 110 can generate instructions to the display device 104 to cause the display device 104 to display the state information. The state information can be presented in a variety of manners.

FIG. 4 illustrates another visual representation 400 of the equipment 302 that can be shown on the display device 104 (shown in FIG. 1) according to one embodiment. The visual representation 400 is a magnified view of the visual representation 300 shown in FIG. 3. For example, the modification input provided by the operator may cause the visual representation 300 to be magnified to the visual representation 400 shown in FIG. 4. Optionally, selection of the part 304A by the selection input may direct the display controller 110 to magnify the visual representation 300 to the visual representation 400 shown in FIG. 4.

In the illustrated example, state information 402 is shown alongside a selected part 304E. The illustrated state information 402 includes the identity of the part 304E (“Part A” in FIG. 4), the age of the part 304E (“Date” in FIG. 4, which can represent when the part 304E was placed into the equipment 302), the duration of use of the part 304E (“Usage” in FIG. 4), and the condition of the part 304E (“Condition” in FIG. 4). Optionally, other state information can be shown. Additionally or alternatively, the state information of one or more parts 304 may be shown by changing the appearance of the parts 304. For example, the parts 304 that are the same type of parts 304 may be shown in a different color, shade, or the like, than other parts.

Returning to the description of the flowchart of the method 200 shown in FIGS. 2A and 2B, flow of the method 200 can proceed from 220 (shown in FIG. 2A) to 222 (shown in FIG. 2B). At 222, a determination is made as to whether the state information is used to key in one or more forms. The operator of the computing system 102 (shown in FIG. 1) may select and/or view the state information for a part 304 (shown in FIG. 3) in order to more easily add at least some of the state information and/or other information to one or more fields of a form. This adding of the information to a form can be referred to as “keying in” information to the form or a “key in” of the information to the form. The fields of the form represent locations or areas of the form where information is input or otherwise added to the form. The form may be an electronic replica or representation of a document that is at least partially filled with information for a variety of reasons or purposes.

For example, an electronic form may be used to log activities performed on the equipment 302 (shown in FIG. 3). Such a form can be used to record what parts 304 were repaired, removed, inspected, or the like, which parts 304 were added to the equipment 302, which operator(s) performed work on the equipment 302, and the like. As another example, the form may be used to acquire one or more replacement parts 304 for the equipment 302 (e.g., to replace a selected part 304), to request repair of the selected part 304 or another part 304, and/or to request inspection of the selected part 304 or another part 304.

If the state information is to be added to the form, then flow of the method 200 can proceed to 224. Otherwise, flow of the method 200 can proceed to 226. At 224, at least some of the state information is entered into one or more fields of a form. As shown in FIG. 1, the computing system 102 may include an application unit 116 that enters the state information into the appropriate fields of the form. The application unit 116 may obtain the form from the memory device 108 (shown in FIG. 1) or another location. The application unit 116 can obtain the state information from the memory device 108 and/or the selection analysis unit 112 (shown in FIG. 1), and then input the state information into the corresponding fields of the form, as described below.

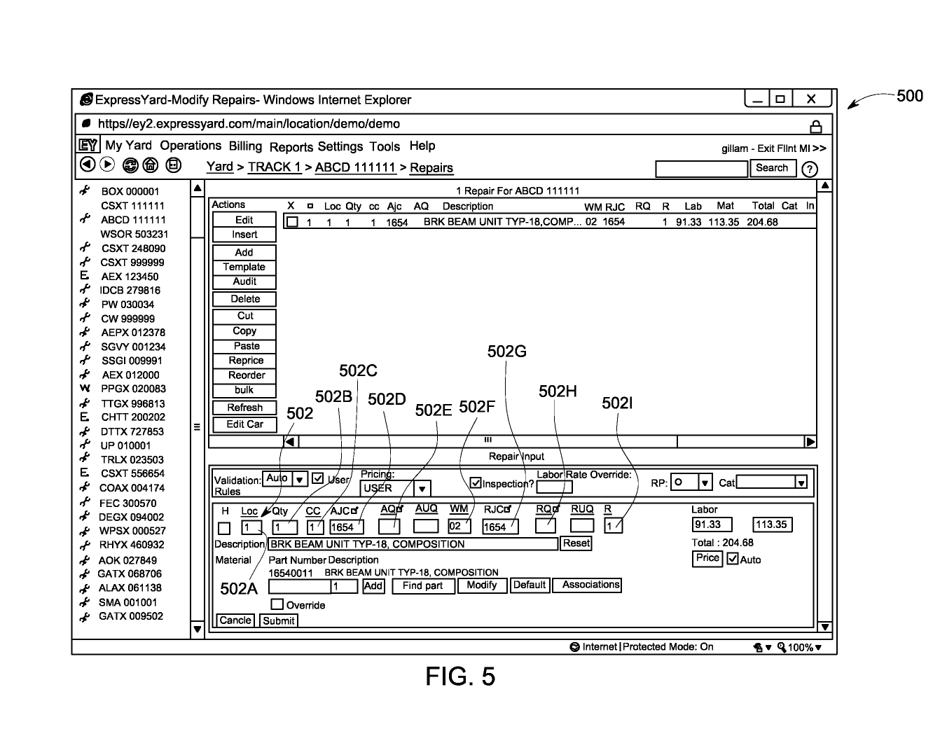

FIG. 5 illustrates an electronic form 500 that may be at least partially completed by the computing system 102 (shown in FIG. 1) according to one embodiment. The display controller 110 (shown in FIG. 1) may generate signals to the display device 104 (shown in FIG. 1) to cause the display device 104 to present the form 500 to the operator.

The form 500 may be automatically obtained from the memory device 108 (shown in FIG. 1) or another location, or may be obtained responsive to receiving input via the input device 106 (shown in FIG. 1). The form 500 includes several fields 502 (e.g., fields 502A-I) that represent areas where information is to be automatically input and/or manually input in order to execute one or more actions with the form 500. For example, the form 500 may need to be filled in with at least some of the information in the fields 502 in order to complete the form 500 and send the form 500 to another location to order one or more replacement parts 304, request inspection of a selected part 304, request repair of the selected part 304, request replacement of the selected part 304, or the like.

The information that is input into the fields 502 may be automatically input by the computing system 102 responsive to the operator selecting the selected part 304. For example, when the operator selects a part 304 as the selected part 304, the state information of the selected part 304 can be obtained and input into the appropriate fields 502. One or more of the fields 502 optionally may be filled out by the operator or another system. In the illustrated example, the field 502A is a location field where the location of the selected part 304 in the equipment 302 is input. The field 502B is a quantity field where the number of selected parts 304 and/or the number of replacement parts 304 needed to replace the selected part 304 is input. The field 502C is a condition field where the condition of the selected part 304 is input. The field 502D is an applied job field where information that identifies the part 304 being repaired, replaced, and/or inspected is input. The field 502E is an additional information field where other state information is input by the computing system 102 and/or the operator. The field 502F is a causation field where information representative of why the selected part 304 is being replaced, repaired, and/or inspected is input. The field 502G is an additional part field where information representative of parts 304 other than the selected part 304 that are being removed from the equipment 302 for the repair, replacement, inspection, or the like, of the selected part 304. The field 502H is an additional job field where other state information about the part 304 other than the selected part 304 is input by the computing system 102 and/or the operator. The field 5021 is a responsibility field where workforce identifier or identifying information can be input. This information can be representative of the operator that is repairing, replacing, inspecting, requesting repair, requesting replacement, requesting inspection, or the like, is input. Optionally, a different number of fields 502 may be used and/or other fields 502 may be used.

The computing system 102 can automatically populate one or more of the fields 502 with state information of the selected part 304 and/or other parts 304 responsive to the operator selecting the selected part 304 and/or selecting the form 500 without further operator intervention. In doing so, the computing system 102 can reduce the time and effort needed to add the information to the form 500. The computing system 102 can receive additional and/or corrective input from the operator. The computing system 102 may send the form 500 with the information in the fields 502 to one or more remote locations. For example, as shown in FIG. 1, the computing system 102 can include a communication device 112 that sends the form 500 with the information to one or more remote locations. The communication device 112 can represent hardware circuits and/or circuitry that include and/or represent one or more computer processors (e.g., microprocessors) that can communicate data signals wirelessly and/or over wired connections. For example, the communication device 112 can include transceiving circuitry and/or an antenna 114 that can wirelessly communicate the form 500 and/or information. Optionally, the antenna 114 can represent a wired connection with one or more cables, busses, or the like, for communicating the form 500 and/or information to the remote locations.

The remote locations that receive the form 500 and/or information can use the form 500 and/or information to execute the replacement, repair, inspection, or the like, of the selected part 304. For example, a remote location may be a place that is not in the same room, building, city, county, state, or country as the computing system 102. The remote location may have an inventory of replacement parts 304 for the selected part 304. Receipt of the form 500 may cause the remote location to treat the form 500 as an order for a replacement part. The remote location may then send the replacement part to the operator and/or prepare the replacement part for pick up by the operator. As another example, the remote location may have one or more other operators who, upon receipt of the form 500, are ordered or scheduled to travel to the location of the equipment 302 to repair the selected part 304, replace the selected part 304, inspect the equipment 302 and/or replacement part 304, or the like. The remote location can then communicate a notification of approval to the computing system 102. This notification can indicate approval to acquire the replacement part, repair the selected part, and/or inspect the selected part 304.

Returning to the description of the flowchart of the method 200 shown in FIG. 2B, at 226, a determination is made as to whether state information of a part 304 (shown in FIG. 3) other than the selected part 304 is to be displayed on the computing system 102 (shown in FIG. 1). For example, the computing system 102 may display state information for one or more parts 304 other than the selected part 304 that are connected with the selected part 304, that are similar or identical to the selected part 304, that may need to be removed in order to access the selected part 304, that have similar state information as the selected part 304 (e.g., the same age, condition, identification, or the like), etc. The operator may direct the computing system 102 to display such additional state information and/or the computing system 102 may automatically display such information when a part 304 is selected by the operator. If additional information is to be displayed, flow of the method 200 can proceed to 228. Otherwise, flow of the method 200 can proceed to 232.

At 228, the state information of one or more parts 304 other than the selected part 304 is obtained. This state information can be obtained from the memory device 108 (shown in FIG. 1) or another location. At 230, the state information for the one or more parts 304 other than the selected part 304 is presented. For example, the display controller 110 (shown in FIG. 1) may generate instruction signals that cause the display device 104 (shown in FIG. 1) to display this state information to the operator.

Returning to the description of the visual representation 400 shown in FIG. 4, the display device 104 (shown in FIG. 1) can display additional state information 404 for a part 304F other than the selected part 304E. For example, when the part 304E is selected by the operator, the computing system 102 also or alternatively may display the identification of another part 304F, the date the part 304F was placed into service, the usage history of the part 304F, the condition of the part 304F, or the like.

The operator can use this display of state information for one or more parts 304 other than the selected part 304 to determine whether to repair, replace, inspect, or the like, the one or more other parts 304. For example, the operator may plan on only replacing the selected part 304E but, upon seeing the age and/or condition of another part 304F that is connected with the selected part 304E and/or that needs to be removed to replace the selected part 304E, the operator may then decide to also replace the other part 304F.

Returning to the description of the flowchart of the method 200 shown in FIG. 2, at 232, a determination is made as to whether a replacement part needs to be located. For example, the computing system 102 (shown in FIG. 1) may determine one or more locations where a replacement part for the selected part 304 (shown in FIG. 3) and/or another part 304 may be. The locations may be stores or other buildings where an inventory of replacement parts are located. These locations may be remote from the computing system 102, such as by being in a different room, building, street, city, county, state, country, or the like. If a replacement part is to be located, then flow of the method 200 can proceed to 234. Otherwise, flow of the method 200 can return to 202 (shown in FIG. 2A). Optionally, instead of returning to 202, flow of the method 200 can return to another operator or can terminate.

With continued reference to the description of the flowchart of the method 200 shown in FIG. 2, and returning to the description of the system 100 shown in FIG. 1, several inventory systems 118 (e.g., systems 118A-C, including “Inventory System 190 1,” “Inventory System #2,” and “Inventory System #N”) communicate with the computing system 102. While three inventory systems 118 are shown, optionally, there may be fewer or more inventory systems 118. These inventory systems 118 can include communication devices that are similar to the communication device 112 to allow the inventory systems 118 to communicate with the computing system 102. The inventory systems 118 may include one or more computing systems that are similar or identical to the computing system 102. Each of the inventory systems 118 can track the quantities of replacement parts 304 at the respective locations of the inventory systems 118.

At 234, the inventories of replacement parts for the selected part 304 or other part 304 at one or more of the inventory systems 118 are determined For example, the computing system 102 may communicate signals to the inventory systems 118 requesting information on the quantity of replacement parts 304 for a selected part 304 or another part 304 at the various inventory systems 118. The inventory systems 118 may respond to the computing system 102 with signals that indicate how many replacement parts 304 are at the different locations of the inventory systems 118.

At 236, the location of the computing system 102 and the locations of the inventories of replacement parts 304 are determined For example, the computing system 102 may include a locator unit 120 that determines the current location of the computing system 102. The locator unit 120 can include hardware circuits or circuitry that include and/or are connected with one or more computer processors (e.g., microprocessors) that determine locations of the computing system 102. The locator unit 120 can include an antenna 122 for receiving signals from global positioning system (GPS) satellites, from cellular towers, or the like. These signals may then be used to determine the location of the locator unit 120 and the computing system 102. Optionally, the operator may input the location and/or the location may be stored in the memory device 108 or another location.

The locations of the inventories of the replacement parts 304 may be communicated to the computing system 102 from the inventory systems 118. Optionally, the locations of the inventory systems 118 may be stored in the memory device 108 or another location accessible by the computing system 102. The selection analysis unit 112 of the computing system 102 may determine the locations of the computing system 102 and the inventory systems 118 using this information.

At 238, inventories of the replacement parts 304 at the inventory systems 118 and/or guidance information is displayed. For example, the display controller 110 of the computing system 102 can direct the display device 104 to display how many replacement parts 304 are at one or more of the inventory systems 118. Optionally, the display controller 110 can direct the display device 104 to display information to guide the operator on how to travel to the various inventory systems 118. This information can include distances between the location of the computing system 102 and the various inventory systems 118, indications of directions to the various inventory systems 118, turn-by-turn navigational instructions to direct the operator to travel from the current location of the computing system 102 to one or more of the inventory systems 118, or the like. The selection analysis unit 112 can determine this information and direct the display controller 110 to cause the display device 104 to present the information to the operator. Following 238, flow of the method 200 can terminate, can return to 202 (shown in FIG. 2A), or return to one or more other operations.

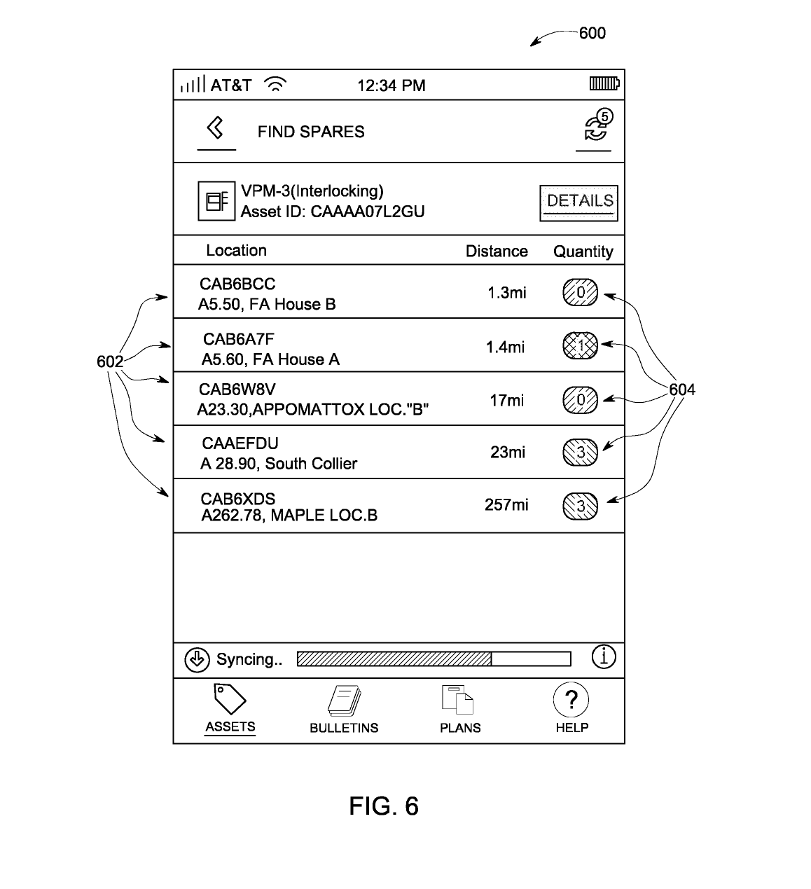

FIG. 6 illustrates another example of a visual representation 600 that may be displayed on the display device 104 of the computing system 102 shown in FIG. 1 according to one embodiment. The display controller 110 (shown in FIG. 1) may direct the display device 104 to present the visual representation 600 (or another form thereof) to inform the operator of the inventories of replacement parts 304 (shown in FIG. 3) at various inventory systems 118 (shown in FIG. 1) and/or where the inventory systems 118 are located relative to the operator.

The visual representation 600 can include location icons 602 that identify the different inventory systems 118. The location identifiers 602 can include a name, address, or the like, of the different inventory systems 118. The selection analysis unit 112 (shown in FIG. 1) can obtain this information from the inventory systems 118, from the memory device 108 (shown in FIG. 1), or another location, and direct the display controller 110 as to how to present the information to the operator on the display device 104.

The visual representation 600 may include inventory icons 604 that represent quantities of replacement parts 304 for a selected part 304 (or another part 304) at the respective inventory locations 118. In the illustrated example, the inventory icons 604 state how many replacement parts 304 are at the corresponding inventory locations 118. The inventory icons 604 also can represent if the respective inventory system 118 has a shortage of replacement parts. For example, if an inventory system 118 has no replacement parts 304 for the selected part 304, then the inventory icon 604 may inform the operator of this absence of replacement parts 304 at that location, such as by displaying a red icon or otherwise informing the operator. If the inventory system 118 has one or more replacement parts 304, but fewer than a designated spare threshold inventory (e.g., number) of replacement parts 304, then the inventory icon 604 may be presented in another color (e.g., yellow) or in another manner to inform the operator of the shortage of replacement parts 304. If the inventory system 118 has at least the spare threshold inventory of replacement parts, then the inventory icon 604 may be presented in another color (e.g., green) or in another manner to inform the operator of the excess of replacement parts 304.

In one aspect, the operator may provide input to the input device of the computing system 102 in order to obtain additional information about one or more of the inventory systems 118. For example, the operator may select a portion of the screen of the display device 104 that corresponds to one or more of the inventory systems 118. The selection analysis unit 112 can examine this input and obtain additional information about the selected inventory system 118 from the inventory system 118 that is selected, from the memory device 108, or from another location. The selection analysis unit 112 can then direct the display controller 110 to cause the display device 104 to present this additional information to the operator via the display device 104.

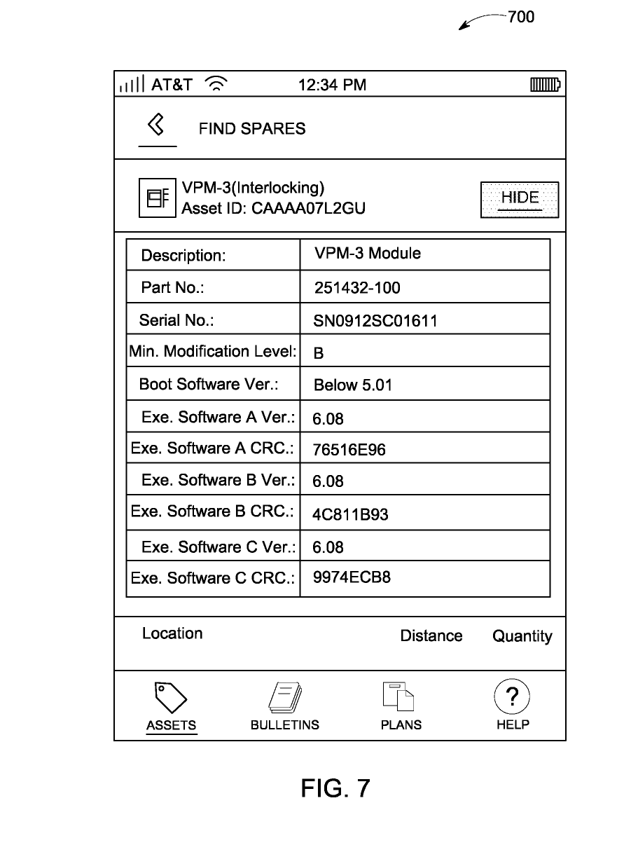

FIG. 7 illustrates another visual representation 700 that may be presented to the operator by the computing system 102 (shown in FIG. 1) according to one embodiment. The visual representation 700 presents additional information about one or more replacement parts that are selected by the operator. In the illustrated example, this additional information includes identifying information, part number, serial number, software information, and the like, but optionally may include other information.

Returning to the description of the visual representation 600 shown in FIG. 6, in one aspect, the computing system 102 (shown in FIG. 1) may determine if the operator can provide assistance to one or more of the inventory systems 118 (shown in FIG. 1) in acquiring additional replacement parts 304 (shown in FIG. 3). For example, some locations of the inventory systems 118 may have less than the threshold spare inventory or may otherwise be in need of additional replacement parts 304. The application unit of the computing system 102 may determine that one or more of the inventory systems 118 are in need of additional replacement parts based on a comparison between the actual inventory of replacement parts and the threshold spare inventory for the various inventory systems 118. Optionally, the application unit may receive a request for additional replacement parts from an inventory system 118 via the communication unit of the computing system 102.

When the operator has found a first inventory system 118 where the operator can obtain a first replacement part 304, the operator can provide inventory selection input to the input device of the computing system 102. This inventory selection input can identify which of the inventory systems 118 that the operator or another person will be traveling to in order to obtain the first replacement part 304. The application unit can examine the inventory selection input and determine if another, second inventory system 118 (or more than one additional inventory system 118) is in need of one or more additional replacement parts. The additional replacement parts can be the same or different from the first replacement part that the operator is to obtain from the first inventory system 118. The analysis unit can then examine the inventories of the additional replacement parts at one or more of the inventory systems 118 other than the second inventory system 118. If one or more of these other inventory systems 118 has extra replacement parts that the second inventory system 118 is in need of, then the analysis unit can determine if the operator will be traveling by or near (e.g., within a designated distance, such as 10 kilometers, 20 kilometers, 50 kilometers, or the like) one or more of these other inventory systems 118 on his or her way to the first inventory system 118. If the operator is traveling by or near these other inventory systems 118 having excess replacement parts that the second inventory system 118 is in need of, then the analysis unit can generate instructions that are displayed by the display controller on the display device 104. These instructions can direct the operator to travel to one or more of these other inventory systems 118, obtain additional replacement parts that may not be needed by the operator, and to take these additional replacement parts to the second inventory system as the operator travels to the first inventory system. Optionally, the analysis unit can determine if the first inventory system is in need of the one or more additional replacement parts (which may be different from the first replacement part), determine if another inventory system between a current location of the operator and the first inventory system has spare or excess replacement parts that are needed by the first inventory system, and then generate the instructions to direct the operator to stop by the other inventory system on his or her way to the first inventory system to pick up one or more spare or excess replacement parts for the first inventory system. In certain applications, the inventory systems may be located relatively far from each other (e.g., 100 kilometers or more), and the computing system 102 can assist with the transfer of replacement parts between the inventory systems when the operator is traveling to or from one or more of the inventory systems.

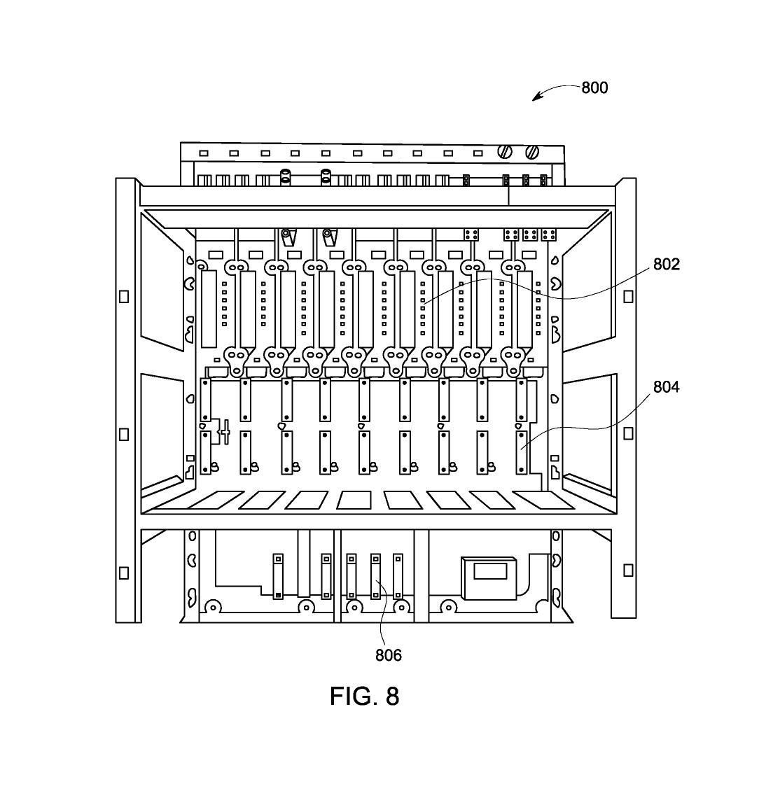

FIG. 8 illustrates a perspective view of other equipment under examination 800 according to one embodiment. The equipment 800 can represent electronic control equipment, such as a computing system, motherboard, or the like, that is coupled with one or more parts, such as electronic cards, cables, or the like, to control operations of other equipment. In the illustrated example, the equipment 800 may be electronic controls for a signal or gate at a crossing between a railroad track and a roadway. The equipment 800 includes several interfaces 802, 804, 806 that are shaped and/or positioned to mate with electronic cards, cables, modules, or the like, to electronically connect the cards, cables, modules, or the like, and to perform operations to control other equipment, such as a gate or signal at the crossing. Alternatively, the equipment 800 may be another type of equipment, may include other interfaces, and/or may include a different number and/or arrangement of the interfaces.

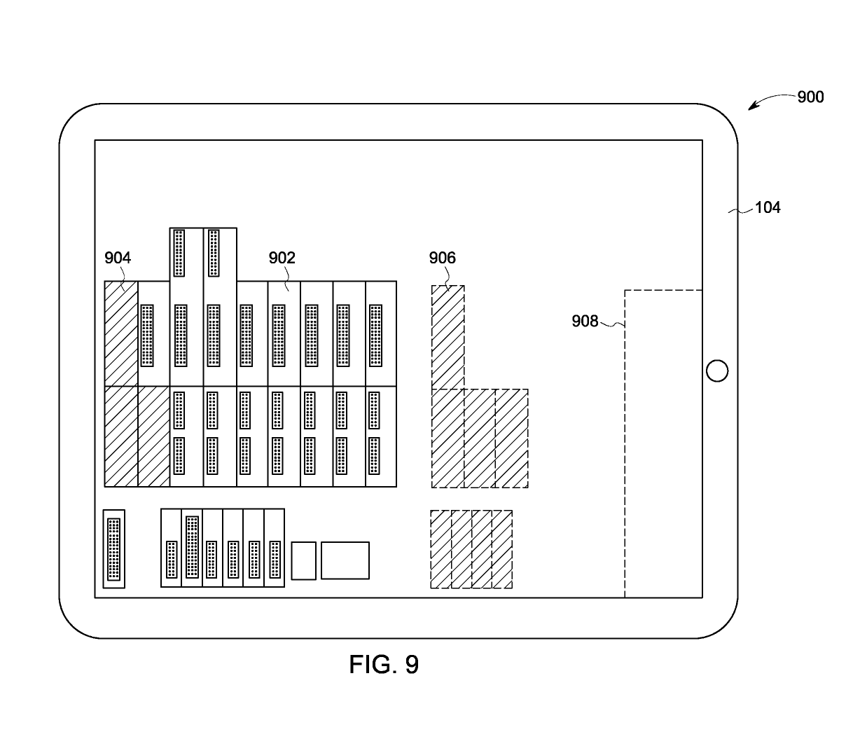

With continued reference to the equipment 800 shown in FIG. 8, FIG. 9 is an example of an object model representation 900 of the equipment 800 that may be generated by the computing system 102 (shown in FIG. 1) for display to the operator in accordance with one embodiment. In contrast to displaying a 2D or 3D image of the equipment 800, as described above, the display controller 110 (shown in FIG. 1) may direct the display device 104 (shown in FIG. 1) to display the object model representation 900 of the equipment 800.

The object model representation 900 includes several shapes that are representative of different parts or components of the equipment 800. In the illustrated example, the shapes are rectangular object models 902, 904, 906, 908, but optionally may have another shape and/or arrangement. The object models can represent parts of the equipment under examination, but may not have shapes or sizes that represent the parts. For example, the parts of the equipment may not have rectangular shapes, but the object models may have rectangular or other geometric shapes.

The object models can include object slot models 902 that represent potential locations in the equipment 800 for current parts of the equipment 800 and/or replacement parts for the equipment 800. For example, the slot models 902 can indicate where the equipment 800 can accept additional parts. In the context of the equipment 800, the slot models 902 can represent which interfaces 802, 804, 806 of the equipment 800 are not currently mated with or otherwise occupied with cards, cables, or the like. As shown in FIG. 9, the slot models 902 can be shown as open or available locations or areas.

The object models can include component object models 904 representative of current locations of parts currently on the equipment. For example, the component models 904 can indicate where the equipment 800 currently has parts. In the context of the equipment 800, the component models 904 can represent which interfaces 802, 804, 806 of the equipment 800 are currently mated with or otherwise occupied with cards, cables, or the like. As shown in FIG. 9, the component models 904 can be shown as filled in areas of the representation 900. Optionally, identifying information of which parts are in the different locations of the equipment 800 can be shown in the component models 904, as shown in FIG. 9. This identifying information can include state information, such as model numbers, serial numbers, part numbers, usage history, date placed into service, or the like.

The object models can include replacement object models 906 representative of replacement parts that are available for use with the equipment 800. For example, the replacement models 906 can indicate which replacement parts are available (e.g., at the location of the equipment 800) for use on or in the equipment 800. In the context of the equipment 800, the replacement models 906 can represent cards, cables, or the like, that are not currently coupled with the interfaces 802, 804, 806 of the equipment 800, but that are available for being coupled with one or more of the interfaces 802, 804, 806. As shown in FIG. 9, the replacement models 906 can be shown as empty areas of the representation 900. Optionally, identifying information of the replacement parts can be shown in the replacement models 906, as shown in FIG. 9. This identifying information can include state information, such as model numbers, serial numbers, part numbers, usage history, condition, or the like.

The object models can include removed object models 908 representative of parts that have been removed from the equipment 800. For example, the removed models 908 can indicate which parts previously were connected with the equipment, but that have been removed (e.g., by the operator during a current repair or inspection of the equipment). In the context of the equipment 800, the removed models 908 can represent cards, cables, or the like, that previously were connected with one or more interfaces 802, 804, 806 of the equipment 800, but that have been removed from the equipment 800.

The operator can use the input device to inform the computing system 102 of changes to one or more parts of the equipment. For example, the operator can provide change-out input to the computing system 102 via the input device of the computing system 102. The change-out input can indicate which current parts of the equipment are being removed from the equipment. In one aspect, the operator can provide the change-out input by selecting a component model in the object model representation and moving (e.g., dragging) the selected component model to the removed object model or another location in the object model representation. Optionally, the operator may provide this change-out input to the computing system 102 in another manner.

Responsive to receiving this change-out input, the selection analysis unit of the computing system 102 can update the object model representation 900. For example, the selection analysis unit may direct the display controller to cause the previous location of the component model to change to indicate that the component model is no longer used in that location of the equipment (e.g., the previous location of the component model can be displayed as an empty area). Additionally or alternatively, the selection analysis unit can direct the display controller to cause the information displayed in the previous location of the component model to change to indicate the presence of the replacement part in that location.

As another example, the operator can provide replacement input to the computing system 102 via the input device of the computing system 102. The replacement input can indicate which replacement parts are being added to the equipment. In one aspect, the operator can provide the replacement input by selecting a replacement model in the object model representation and moving (e.g., dragging) the selected replacement model to a slot object model or another location in the object model representation. Optionally, the operator may provide this replacement input to the computing system 102 in another manner.

Responsive to receiving this replacement input, the selection analysis unit of the computing system 102 can update the object model representation 900. For example, the selection analysis unit may direct the display controller to cause the previous location of the replacement model to change to indicate that the replacement model is no longer available as a replacement part (e.g., the previous location of the replacement model can be displayed as an empty area). Additionally or alternatively, the selection analysis unit can direct the display controller to cause the information displayed in the previous location of the slot model to change to indicate the presence of the replacement part in that location.

Optionally, the operator may use the input device of the computing system to select one or more object models of the equipment and obtain additional views and/or information about the parts represented by the selected object model. For example, the operator may select an object model and “drill down” using the input device to obtain additional state information. In one aspect, selection of an object model may cause another object model representation to be displayed by the computing system, with this additional object model representation representing the part selected by the operator. The part may have additional parts (e.g., sub-parts) that can be selected, moved, replaced, or the like, by the operator, as described above.

In one embodiment, a method (e.g., for providing an interactive asset management interface to an operator) includes displaying (e.g., using a display device of a computing system having one or more processors) a visual representation of equipment under examination and one or more current parts of the equipment under examination. The method also can include receiving (e.g., using the computing system) a selection input from an operator of the computing system that identifies a selected part of the one or more current parts of the equipment under examination and obtaining state information of the selected part from one or more memory devices responsive to receiving the selection input. The method also can include at least one of: adding the state information to one or more fields of a form used to at least one of acquire one or more replacement parts for the selected part, request repair of the selected part, or request inspection of the selected part; and/or displaying the state information of the selected part using the display device of the computing system with the visual representation of the selected part.

In one aspect, the method also can include receiving (e.g., using the computing system) a modification input from the operator of the computing system. The modification input can cause the computing system to change the visual representation of the equipment under examination.

In one aspect, the visual representation that is displayed can include an exploded three-dimensional view of the equipment under examination and the modification input that is received from the operator can include at least one of a rotation of the visual representation, a change in magnification of the visual representation, and/or a change in perspective of the visual representation.

In one aspect, obtaining the state information can include determining at least one of a condition of the selected part, an age of the selected part, a duration of use of the selected part, and/or a service history of the selected part.

In one aspect, obtaining the state information can include determining at least one of: a location of the selected part on the equipment under examination; a quantity of the replacement part to be acquired; a job identifier that represents the selected part being at least one of replaced, repaired, or inspected; a causation identifier that represents a cause for the at least one of acquiring the replacement part, requesting repair of the selected part, or requesting inspection of the selected part; an associated removed part identifier that represents one or more additional parts of the equipment under examination that will be removed from the equipment under examination when the selected part is at least one of replaced, repaired, or inspected; and/or a workforce identifier that represents one or more persons that at least one of replace the selected part, repair the selected part, or inspect the selected part.

In one aspect, the method can include obtaining associated state information of an additional part of the equipment under examination responsive to receiving the selection input. The additional part may be different from the selected part. The method also can include displaying the associated state information of the additional part with the state information of the selected part using the display device of the computing system.

In one aspect, the method can include receiving (e.g., using an input device of the computing system) an identification of the equipment under examination and obtaining the visual representation of the equipment under examination from at least one of the one or more memory devices.

In one aspect, receiving the identification of the equipment under examination can include at least one of optically scanning an image coupled with the equipment under examination and/or electromagnetically reading the identification of the equipment under examination from a tag coupled with the equipment under examination.

In one aspect, the method can include communicating the form with the state information added to the one or more fields to a remote location and receiving a notification of approval from the remote location to at least one of acquire the one or more replacement parts, repair the selected part, or inspect the selected part responsive to communicating the form with the state information added to the one or more fields.

In one aspect, the method can include determining a current location of the computing system using a locator unit of the computing system, determining one or more different remote locations of inventories of the one or more replacement parts using the computing system, and displaying quantities of the one or more replacements parts at the one or more different remote locations and one or more distances between the current location of the computing system and the one or more different remote locations.

In one aspect, the method can include receiving a selection of at least one of the one or more different remote locations from the operator and generating at least one of visual instructions or audible instructions to guide the operator from the current location of the computing system to the selection of the at least one of the one or more different remote locations.

In one aspect, the method can include generating a notification to the operator representing which of the one or more different remote locations have at least a designated threshold spare inventory of the one or more replacement parts.

In one aspect, the method can include receiving a selection of at least one of the one or more different remote locations from the operator, identifying which of the one or more different remote locations have the inventories of the one or more replacement parts that are no greater than the designated threshold spare inventory, and generating at least one of a visible instruction or audible instruction using the computing system to direct the operator to obtain a first amount of the replacement parts to replace the selected part, obtain an additional amount of the replacement parts from a first remote location of the one or more different remote locations, and take the additional amount of the replacement parts to the one or more different remote locations that are identified so that the one or more different remote locations that are identified have at least the designated threshold spare inventory of the one or more replacement parts.

In one aspect, the method can include displaying the visual representation of the equipment under examination by displaying an object model representation of the equipment under examination. The object model representation can include at least one of one or more object slot models representative of potential locations for at least one of the one or more current parts or the one or more replacement parts, one or more component object models representative of current locations of the one or more current parts, one or more replacement object models representative of the one or more replacement parts being available to replace the one or more current parts, and/or one or more removed object models representative of at least one of the one or more current parts being removed from service in the equipment under examination.

In one aspect, the object model representation can include the one or more component object models and the one or more removed object models. The method also can include receiving change-out input from the operator (e.g., using the computing system or another device). The change-out input can cause the computing system to move at least one of the one or more component object models to the one or more removed object models in order to indicate that at least one of the current parts is being removed from service from the equipment under examination.

In one aspect, the object model representation can include the one or more object slot models and at least one of the one or more component object models and/or the one or more replacement object models. The method also can include receiving replacement input from the operator using the computing system. The replacement input can cause the computing system to move at least one of the one or more component object models and/or the one or more replacement object models to the one or more object slot models in order to indicate that at least one of the one or more replacement parts and/or the one or more current parts is being placed into service in the equipment under examination.

In another embodiment, a system (e.g., an asset management system) includes a computing system having one or more processors. The one or more processors are configured to direct a display device to present a visual representation of equipment under examination and one or more current parts of the equipment under examination. The one or more processors also are configured to receive a selection input from an operator of the computing system that identifies a selected part of the one or more current of the equipment under examination and to obtain state information of the selected part from one or more memory devices responsive to receiving the selection input. The one or more processors also are configured to at least one of: add the state information to one or more fields of a form used to at least one of acquire one or more replacement parts for the selected part, request repair of the selected part, and/or request inspection of the selected part; and/or display the state information of the selected part using the display device of the computing system with the visual representation of the selected part.

In one aspect, the one or more processors also are configured to receive modification input from an operator of the computing system and to change the visual representation of the equipment under examination responsive to receiving the modification input.

In one aspect, the one or more processors are configured to direct the display device to present the visual representation as including an exploded three-dimensional view of the equipment under examination and to at least one of rotate the visual representation, change magnification of the visual representation, or change perspective of the visual representation based on the modification input that is received.

In one aspect, the one or more processors are configured to obtain the state information by determining at least one of a condition of the selected part, an age of the selected part, a duration of use of the selected part, or a service history of the selected part.

In one aspect, the one or more processors are configured to obtain the state information by determining at least one of: a location of the selected part on the equipment under examination; a quantity of the replacement part to be acquired; a job identifier that represents the selected part being at least one of replaced, repaired, and/or inspected; a causation identifier that represents a cause for the at least one of acquiring the replacement part, requesting repair of the selected part, and/or requesting inspection of the selected part; an associated removed part identifier that represents one or more additional parts of the equipment under examination that will be removed from the equipment under examination when the selected part is at least one of replaced, repaired, and/or inspected; and/or a workforce identifier that represents one or more persons that at least one of replace the selected part, repair the selected part, and/or inspect the selected part.

In one aspect, the one or more processors also are configured to obtain associated state information of an additional part of the equipment under examination responsive to receiving the selection input. The additional part can be different from the selected part. The one or more processors can be configured to direct the display device to present the associated state information of the additional part with the state information of the selected part.

In one aspect, the one or more processors also are configured to receive an identification of the equipment under examination and to obtain the visual representation of the equipment under examination from at least one of the one or more memory devices.

In one aspect, the one or more processors are configured to receive the identification of the equipment under examination by at least one of optically scanning an image coupled with the equipment under examination or electromagnetically reading the identification of the equipment under examination from a tag coupled with the equipment under examination.

In one aspect, the one or more processors are configured to communicate the form with the state information added to the one or more fields to a remote location and to receive a notification of approval from the remote location to at least one of acquire the replacement part, repair the selected part, and/or inspect the selected part responsive to communicating the form with the state information added to the one or more fields.

In one aspect, the system also includes a locator unit configured to determine a current location of the computing system. The one or more processors also can be configured to determine one or more different remote locations of inventories of the one or more replacement parts using the computing system and to direct the display device to present quantities of the one or more replacements parts at the one or more different remote locations and one or more distances between the current location of the computing system and the one or more different remote locations.

In one aspect, the one or more processors also are configured to receive a selection of at least one of the one or more different remote locations from the operator and to direct the display device to generate at least one of visual instructions or audible instructions to guide the operator from the current location of the computing system to the selection of the at least one of the one or more different remote locations.

In one aspect, the one or more processors are configured to direct the display device to generate a notification to the operator that represents which of the one or more different remote locations have at least a designated threshold spare inventory of the one or more replacement parts.

In one aspect, the one or more processors are configured to receive a selection of at least one of the one or more different remote locations from the operator, to identify which of the one or more different remote locations have the inventories of the one or more replacement parts that are no greater than the designated threshold spare inventory, and to direct the display device to generate at least one of a visible instruction or audible instruction to: direct the operator to obtain a first amount of the replacement parts to replace the selected part, obtain an additional amount of the replacement parts from a first remote location of the one or more different remote locations, and take the additional amount of the replacement parts to the one or more different remote locations that are identified so that the one or more different remote locations that are identified have at least the designated threshold spare inventory of the one or more replacement parts.

In one aspect, the one or more processors are configured to direct the display device to display an object model representation of the equipment under examination. The object model representation includes at least one of: one or more object slot models representative of potential locations for at least one of the one or more current parts or the one or more replacement parts, one or more component object models representative of current locations of the one or more current parts, one or more replacement object models representative of the one or more replacement parts being available to replace the one or more current parts, and/or one or more removed object models representative of at least one of the one or more current parts being removed from service in the equipment under examination.

In one aspect, the object model representation includes the one or more component object models and the one or more removed object models. The one or more processors also can be configured to receive change-out input from the operator and, responsive to receiving the change-out input, to direct the display device to visually present moving at least one of the one or more component object models to the one or more removed object models to indicate that at least one of the current parts is being removed from service from the equipment under examination.

In one aspect, the object model representation includes the one or more object slot models and at least one of the one or more component object models or the one or more replacement object models. The one or more processors also can be configured to receive replacement input from the operator using the computing system and, responsive to receiving the replacement input, to direct the display device to visually present moving at least one of the one or more component object models or the one or more replacement object models to the one or more object slot models to indicate that at least one of the one or more replacement parts or the one or more current parts is being placed into service in the equipment under examination.

In another embodiment, a system (e.g., an asset management system) includes a computing system having one or more processors configured to direct a display device to present a visual representation of equipment under examination and one or more current parts of the equipment under examination. The one or more processors also are configured to direct the display device to display an object model representation of the equipment under examination. The object model representation includes at least one of: one or more object slot models representative of potential locations for at least one of the one or more current parts or the one or more replacement parts, one or more component object models representative of current locations of the one or more current parts, one or more replacement object models representative of the one or more replacement parts being available to replace the one or more current parts, and/or one or more removed object models representative of at least one of the one or more current parts being removed from service in the equipment under examination. The one or more processors are configured to receive input from the operator to move one or more of the component object models and/or one or more of the replacement object models to indicate at least one of removal of the one or more current parts and/or addition of one or more of the replacement parts.

In one aspect, the object model representation includes the one or more component object models and the one or more removed object models. The one or more processors also are configured to receive change-out input from the operator and, responsive to receiving the change-out input, to direct the display device to visually present moving at least one of the one or more component object models to the one or more removed object models to indicate that at least one of the current parts is being removed from service from the equipment under examination.

In one aspect, the object model representation includes the one or more object slot models and at least one of the one or more component object models or the one or more replacement object models. The one or more processors also are configured to receive replacement input from the operator using the computing system and, responsive to receiving the replacement input, to direct the display device to visually present moving at least one of the one or more component object models or the one or more replacement object models to the one or more object slot models to indicate that at least one of the one or more replacement parts or the one or more current parts is being placed into service in the equipment under examination.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A method comprising:
displaying, using a display device of a computing system having one or more processors, a visual representation of equipment under examination and one or more current parts of the equipment under examination;
receiving, using the computing system, a selection input from an operator of the computing system that identifies a selected part of the one or more current parts of the equipment under examination;
obtaining state information of the selected part from one or more memory devices responsive to receiving the selection input; and
at least one of:
adding the state information to one or more fields of a form used to at least one of acquire one or more replacement parts for the selected part, request repair of the selected part, or request inspection of the selected part; or
displaying the state information of the selected part using the display device of the computing system with the visual representation of the selected part.

2. The method of claim 1, further comprising receiving, using the computing system, a modification input from the operator of the computing system, the modification input changing the visual representation of the equipment under examination.

3. The method of claim 1, wherein obtaining the state information includes determining at least one of a condition of the selected part, an age of the selected part, a duration of use of the selected part, or a service history of the selected part.

4. The method of claim 1, further comprising:
obtaining associated state information of an additional part of the equipment under examination responsive to receiving the selection input, the additional part being different from the selected part; and
displaying the associated state information of the additional part with the state information of the selected part using the display device of the computing system.

5. The method of claim 1, further comprising:
receiving, using an input device of the computing system, an identification of the equipment under examination; and
obtaining, responsive to the identification, the visual representation of the equipment under examination from at least one of the one or more memory devices.

6. The method of claim 1, further comprising:
communicating the form with the state information added to the one or more fields to a remote location; and
receiving a notification of approval from the remote location to at least one of acquire the one or more replacement parts, repair the selected part, or inspect the selected part responsive to communicating the form with the state information added to the one or more fields.

7. The method of claim 1, further comprising:
determining a current location of the computing system using a locator unit of the computing system;
determining one or more different remote locations of inventories of the one or more replacement parts using the computing system; and
displaying quantities of the one or more replacements parts at the one or more different remote locations and one or more distances between the current location of the computing system and the one or more different remote locations.

8. The method of claim 7, further comprising:
receiving a selection of at least one of the one or more different remote locations from the operator; and
generating at least one of visual instructions or audible instructions to guide the operator from the current location of the computing system to the selection of the at least one of the one or more different remote locations.

9. The method of claim 7, further comprising generating a notification to the operator representing which of the one or more different remote locations have at least a designated threshold spare inventory of the one or more replacement parts.

10. The method of claim 9, further comprising:
receiving a selection of at least one of the one or more different remote locations from the operator;
identifying which of the one or more different remote locations have the inventories of the one or more replacement parts that are no greater than the designated threshold spare inventory; and
generating at least one of a visible instruction or audible instruction using the computing system to direct the operator to obtain a first amount of the one or more replacement parts to replace the selected part, obtain an additional amount of the one or more replacement parts from a first remote location of the one or more different remote locations, and take the additional amount of the one or more replacement parts to the one or more different remote locations that are identified so that the one or more different remote locations that are identified have at least the designated threshold spare inventory of the one or more replacement parts.

11. The method of claim 1, wherein displaying the visual representation of the equipment under examination includes displaying an object model representation of the equipment under examination, the object model representation including at least one of:
one or more object slot models representative of potential locations for at least one of the one or more current parts or the one or more replacement parts,
one or more component object models representative of current locations of the one or more current parts,
one or more replacement object models representative of the one or more replacement parts being available to replace the one or more current parts, or
one or more removed object models representative of at least one of the one or more current parts being removed from service in the equipment under examination.

12. The method of claim 11, wherein the object model representation includes the one or more component object models and the one or more removed object models, and further comprising receiving change-out input from the operator using the computing system, the change-out input moving at least one of the one or more component object models to the one or more removed object models to indicate that at least one of the current parts is being removed from service from the equipment under examination.

13. The method of claim 11, wherein the object model representation includes the one or more object slot models and at least one of the one or more component object models or the one or more replacement object models, and further comprising receiving replacement input from the operator using the computing system, the replacement input moving at least one of the one or more component object models or the one or more replacement object models to the one or more object slot models to indicate that at least one of the one or more replacement parts or the one or more current parts is being placed into service in the equipment under examination.

14. A system comprising:
a computing system having one or more processors, the one or more processors configured to direct a display device to present a visual representation of equipment under examination and one or more current parts of the equipment under examination, the one or more processors also configured to receive a selection input from an operator of the computing system that identifies a selected part of the one or more current parts of the equipment under examination and to obtain state information of the selected part from one or more memory devices responsive to receiving the selection input, the one or more processors also configured to at least one of:
add the state information to one or more fields of a form used to at least one of acquire one or more replacement parts for the selected part, request repair of the selected part, or request inspection of the selected part; or
display the state information of the selected part using the display device of the computing system with the visual representation of the selected part.

15. The system of claim 14, wherein the one or more processors also are configured to receive modification input from the operator of the computing system and to change the visual representation of the equipment under examination responsive to receiving the modification input.

16. The system of claim 14, wherein the one or more processors are configured to obtain the state information by determining at least one of a condition of the selected part, an age of the selected part, a duration of use of the selected part, or a service history of the selected part.

17. The system of claim 14, wherein the one or more processors also are configured to obtain associated state information of an additional part of the equipment under examination responsive to receiving the selection input, the additional part being different from the selected part, and to direct the display device to present the associated state information of the additional part with the state information of the selected part.

18. A system comprising:
a computing system having one or more processors, the one or more processors configured to direct a display device to present a visual representation of equipment under examination and one or more current parts of the equipment under examination, the one or more processors also configured to direct the display device to display an object model representation of the equipment under examination, the object model representation including at least one of:
one or more object slot models representative of potential locations for at least one of the one or more current parts or one or more replacement parts being available to replace the one or more current parts,
one or more component object models representative of current locations of the one or more current parts,
one or more replacement object models representative of the one or more replacement parts being available to replace the one or more current parts, or
one or more removed object models representative of at least one of the one or more current parts being removed from service in the equipment under examination,
wherein the one or more processors are configured to receive input from an operator of the computing system to move at least one of the component object models or the replacement object models to indicate at least one of removal of the one or more current parts or addition of at least one of the one or more replacement parts to the equipment under examination.

19. The system of claim 18, wherein the object model representation includes the one or more component object models and the one or more removed object models, and wherein the one or more processors also are configured to receive change-out input from the operator and, responsive to receiving the change-out input, to direct the display device to visually present moving at least one of the one or more component object models to the one or more removed object models to indicate that at least one of the current parts is being removed from service from the equipment under examination.

20. The system of claim 18, wherein the object model representation includes the one or more object slot models and at least one of the one or more component object models or the one or more replacement object models, and wherein the one or more processors also are configured to receive replacement input from the operator using the computing system and, responsive to receiving the replacement input, to direct the display device to visually present moving at least one of the one or more component object models or the one or more replacement object models to the one or more object slot models to indicate that at least one of the one or more replacement parts or the one or more current parts is being placed into service in the equipment under examination.
